(19) United States
(12) Patent Application Publication
(10) Pub. No.: US 2004/0027781 A1
(43) Pub. Date: Feb. 12, 2004

(54) Low loss RF bias electrode for a plasma reactor with enhanced wafer edge RF coupling and highly efficient wafer cooling

(76) Inventors: Hiroji Hanawa, Sunnyvale, CA (US); Andrew Nguyen, San Jose, CA (US); Kartik Ramaswamy, Santa Clara, CA (US); Kenneth S. Collins, San Jose, CA (US); Gonzalo Antonio Monroy, San Francisco, CA (US); Bryan Y. Pu, San Jose, CA (US)

Correspondence Address: Patent Counsel, Applied Materials, Inc., P.O. Box 450-A, Santa Clara, CA, 95035, US

(21) Appl. No.: 10/218,179

(22) Filed: Aug. 12, 2002

(51) Int. Cl. H01H 1/00

(52) U.S. Cl. 361/234

(57) ABSTRACT

A plasma reactor for processing a semiconductor wafer having a wafer diameter within a vacuum chamber of the reactor has a wafer support pedestal in the vacuum chamber extending upwardly from a floor of the vacuum chamber. The wafer support pedestal includes a top layer having a generally planar surface for supporting the wafer, the top layer having a diameter on the order of the wafer diameter. A conductive base underlies and supports the top layer, the conductive base having a diameter at least as great as the wafer diameter. An RF power output terminal below the floor of the vacuum chamber transmits power through an elongate inner conductor within and generally parallel to an axis of the wafer support pedestal, the elongate inner conductor having a bottom end connected to the RF power output terminal and a top end terminated at the conductive base. A hollow cylindrical outer conductor coaxial with the inner conductor has a diameter less than the diameter of the hollow cylindrical liner wall and is separated from the elongate inner conductor by a coaxial gap. A conductive upper ground plane annulus is generally coaxial with the inner and outer conductors and located in a plane near the top end of the inner conductor, the conductive upper ground plane annulus having an inner edge connected to the hollow cylindrical outer conductor and an outer edge coupled to a ground potential.

### BACKGROUND

A plasma reactor that can process a semiconductor wafer for integrated circuit fabrication typically employs an electrostatic wafer support pedestal or “chuck” to hold the semiconductor wafer in the reactor chamber. A buried electrode within an insulating layer under the wafer is charged with a D.C. voltage to electrostatically hold the wafer in place. RF bias power is applied to the wafer support pedestal for capacitively coupling RF power to the plasma, so that the pedestal functions as an RF bias power electrode. The reactor chamber is typically maintained at a sub-atmospheric pressure while process gases are introduced. For dielectric or silicon dioxide etch processes, the process gases are typically fluoro-carbons or fluoro-hydrocarbons. The reactor chamber is typically evacuated through the floor of the chamber and the chuck holds the wafer above the floor, typically nearly midway between the chamber floor and the chamber ceiling. Thus, the wafer pedestal has a substantial height relative to the chamber height and diameter. The RF bias power generator and impedance match element thereof are placed below the chamber floor and RF power is coupled from the match element at the floor and through the chuck up to the wafer. Typically, the chamber walls are connected to the ground or return potential of the RF bias power generator while a bias power conductor extends from the RF generator and match output through the wafer support pedestal. Typically, the bias power conductor is connected to the buried electrode in the electrostatic chuck, so that RF bias power is capacitively coupled from the buried electrode to the wafer (and thence to the plasma). In addition, a D.C. wafer chucking voltage is applied to the buried electrode to hold the wafer.

Not all of the power delivered by the RF bias impedance match reaches the plasma, due to losses associated with the bias power conductor and surrounding structure of the reactor. Such losses represent a certain lack of control over process conditions and impede reactor performance. The present inventors have recognized that this is due at least in part to the length of the bias power conductor and the corresponding size of the surrounding reactor structural elements. (This will be discussed in greater length in the detailed description below.) However, the bias power conductor length cannot be shortened to ameliorate the problem, because the pedestal height cannot be shortened without compromising the performance of the reactor. Therefore, there has seemed to be no way in which to solve the problem of power loss between the RF bias match element and the plasma.

In addition, the large inductances associated with this structure, in conjunction with the capacitances arising between the RF bias electrode and ground as well as stray capacitances between the RF bias power conductor and ground, can produce resonances that limit the useful frequency range or shift voltage and current characteristics. For example, harmonics of the fundamental RF bias frequency generated in the non-linear plasma sheath can interact with the aforementioned resonances in the wafer support pedestal 135, changing plasma sheath characteristics (e.g. ion energy distribution) and/or leading to power losses.

A secondary but related problem is that the bias power conductor tends to radiate RF noise at the bias frequency that must be carefully shielded around the bottom of the wafer support pedestal to avoid saturating instrumentation in the reactor and exceeding RF exposure limits.

A significant problem in such a reactor is that process performance is very poor near the wafer periphery. This creates an annular dead zone at the wafer periphery that yields no useful product. The poor yield in this zone is due to a number of problems, including etch profile tilting due to non-perpendicular electric field, poor center-to-edge etch depth uniformity and narrow process window for balancing photoresist selectivity with etch depth and rate. If process performance were enhanced near the wafer periphery, the radial extent of the dead zone could be reduced, leading to higher production yield. The problem of poor process performance at the wafer periphery arises from a number of factors:

(1) In order to avoid plasma contacting the wafer support pedestal and attacking it or deriving contamination from it, the wafer edge must extend beyond the wafer support pedestal edge, typically by about 2 mm. This, combined with the fact that the electrostatic chuck buried electrode cannot extend to the periphery of the wafer support pedestal enclosing it, means that capacitive coupling to the plasma is poor at the wafer periphery, so that plasma density and/or plasma sheath voltage falls off rapidly at the wafer periphery. In an etch process, for example, the etch rate is much lower at the wafer periphery than at the wafer center. This may also lead to a greater tendency for etch stopping near the wafer periphery.

(2) It is difficult if not impossible to control the wafer temperature near or at the wafer edge. Since wafer cooling is essential to a good balance between oxide etch and polymer deposition in high aspect ratio openings in a silicon dioxide etch process, such a process will produce poor results at the wafer periphery. It is not possible to control wafer temperature near the wafer periphery because the helium cooling gas present between the wafer and the top surface of the electrostatic chuck must be sealed within the wafer periphery to avoid flooding the reactor chamber with helium gas. Such a seal is accomplished by terminating the small helium gas passages in the chuck top surface at a radius that is within the radius of the wafer periphery. This leaves a small annular peripheral zone of the wafer that is not contacted by the helium gas. The helium gas subsisting between the wafer and the chuck serves to enhance thermal conductivity by more than one order to magnitude. Therefore, thermal control near the wafer edge is highly inferior relative to the remainder of the wafer, leading to a proportionate degradation of etch performance near the wafer periphery.

Such poor process performance near the wafer periphery has been addressed in the past by changing or introducing other elements of the reactor chamber to compensate. For example, the etch rate uniformity problem has been addressed by providing a multiple zone gas feed apparatus in which process gas is fed into the chamber at different gas flow rates for different radial zones of the process region overlying the wafer. It would be better, however, if the problem of poor process control at the wafer periphery were to be solved at the origin of the problem, namely in the electrostatic wafer support pedestal, so that other elements of the reactor need not be compromised or modified to solve the problem.

In addition to the difficulty of cooling the wafer near the periphery, variations in wafer temperature across the entire wafer surface seem to be unavoidable and lead to non-uniformities in process performance over the whole wafer. Such variations in wafer temperature arise from the difficulty of distributing water or coolant within the wafer support pedestal in a uniform manner. Typically, the most uniform distribution of coolant currently is attained by flowing the coolant through serpentine passages within a planar layer of pedestal. The serpentine passages meander for optimum area coverage and are thin so as minimize gaps or voids in coverage. The present inventors have realized that temperature non-uniformities arise from thermal loading along the elongate path of each serpentine coolant helium passage. Moreover, thermal loading is aggravated by the limited fluid flow rate through the thin serpentine passages.

### SUMMARY OF THE DISCLOSURE

A plasma reactor for processing a semiconductor wafer having a wafer diameter within a vacuum chamber of the reactor has a wafer support pedestal in the vacuum chamber extending upwardly from a floor of the vacuum chamber. The wafer support pedestal includes a top layer having a generally planar surface for supporting the wafer, the top layer having a diameter on the order of the wafer diameter. A conductive base underlies and supports the top layer, the conductive base having a diameter at least as great as the wafer diameter. An RF power output terminal below the floor of the vacuum chamber transmits power through an elongate inner conductor within and generally parallel to an axis of the wafer support pedestal, the elongate inner conductor having a bottom end connected to the RF power output terminal and a top end terminated at the conductive base. A hollow cylindrical outer conductor coaxial with the inner conductor has a diameter less than the diameter of the hollow cylindrical liner wall and is separated from the elongate inner conductor by a coaxial gap. A conductive upper ground plane annulus is generally coaxial with the inner and outer conductors and located in a plane near the top end of the inner conductor, the conductive upper ground plane annulus having an inner edge connected to the hollow cylindrical outer conductor and an outer edge coupled to a ground potential.

A powered process kit includes an annular collar assembly surrounding the top layer and extending radially beyond the diameter of the top layer. The annular collar assembly can further include an RF coupling ring of a high capacitance material underlying a portion of the collar assembly near an inner radius of the collar, the high capacitance ring overlying at least a peripheral portion of the RF-driven conductive base, whereby to capacitively couple RF power from the conductive base to a zone of the vacuum chamber overlying a peripheral portion of the wafer. The high capacitance material can have a dielectric constant approximately double that of the low capacitance material, for example. The high capacitance material has a large dielectric constant and the low capacitance material has a low dielectric constant, the difference between the high and low dielectric constants being sufficient to compensate for edge effects in the plasma near the periphery of the wafer.

The conductive base can include a coolant layer with parallel coolant flow channels, consisting of an upper coolant manifold having a generally planar extent and located at a first axial location, a lower coolant manifold having a generally planar extent corresponding to the planar extent of the upper coolant manifold and located at a second axial location below the axial location of the upper coolant manifold, an intermediate wall separating the upper and lower coolant manifolds and defining a ceiling of the lower coolant manifold and a floor of the upper coolant manifold, a first external conduit connected through the bottom wall to the lower coolant manifold, a second external conduit passing through the bottom wall and connected through the intermediate wall to the upper coolant manifold, plural parallel passages in the intermediate wall for coolant flow between the upper and lower coolant manifolds, and a coolant pump output port connected to an output end of one of the first and second external conduits and a coolant pump return port connected to another one of the first and second external conduits.

### BRIEF DESCRIPTION OF THE DRAWINGS

FIG. 1 is a simplified diagram of a plasma reactor incorporating various features of the invention.

FIG. 2 is an enlarged view of the wafer support pedestal of the reactor of FIG. 1.

FIG. 3 is an enlarged view of a portion of the wafer support pedestal of FIG. 2.

FIG. 4 is an enlarged view corresponding to FIG. 3 of a portion of the wafer support pedestal of FIG. 2 in accordance with another implementation.

FIG. 5 is an enlarged view of a portion of the drawing of FIG. 3 illustrating a fastener assembly thereof.

FIG. 6 is a cross-sectional view of a coolant plate of the ESC base of the wafer support pedestal of FIG. 2.

FIG. 7 is an exploded perspective bottom view of the coolant plate of FIG. 6.

### DETAILED DESCRIPTION

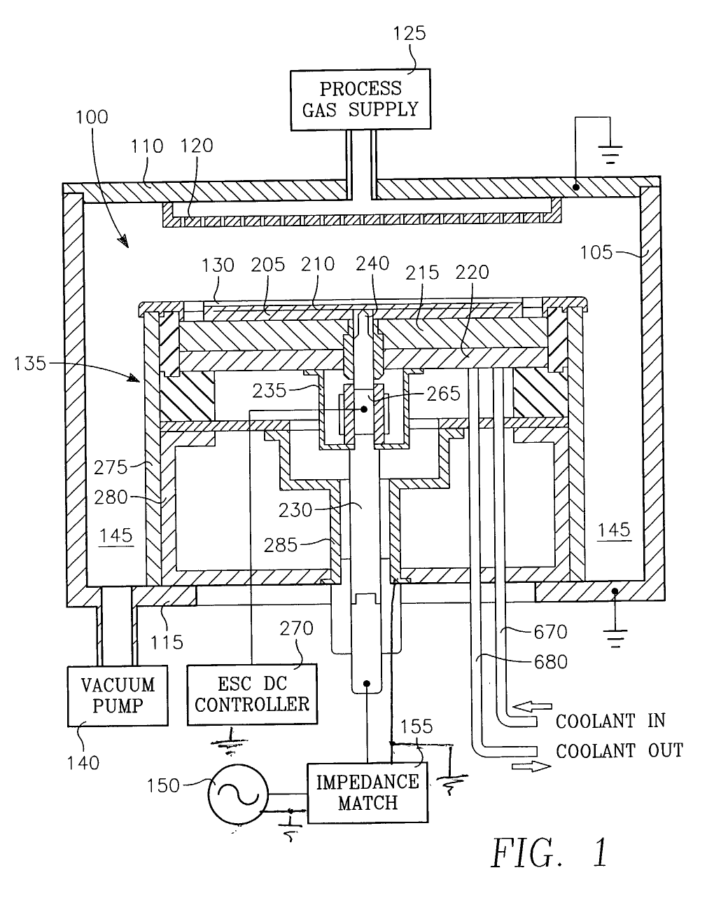

FIG. 1 illustrates a plasma reactor for processing a semiconductor wafer. The reactor includes a vacuum chamber 100 defined by a cylindrical side wall 105, an overhead ceiling 110 and a floor 115. Process gas injection apparatus such as an overhead showerhead 120 is mounted near the ceiling 110 and coupled to a process gas supply 125. A semiconductor wafer 130 is supported within the reactor chamber 100 on the top surface of a wafer support pedestal 135. Gas pressure within the chamber is maintained at a sub-atmospheric pressure, for example, by a vacuum pump 140 coupled to the chamber 100 through a passage in the floor 115, so that gas is pumped out of the chamber through a pumping annulus 145 defined between the wafer support pedestal 135 and the side wall 105. Plasma RF bias power is applied to the process gases within the chamber by an RF power generator 150 connected to the wafer support pedestal 135 through an impedance match element 155. The RF power generator can deliver RF power at 13.56 MHz, for example. The wafer support pedestal 135 therefore functions as a bias power electrode. Either or both of the ceiling 110 and the side wall 105 are grounded and therefore serve as a counter-electrode or return path for the bias RF power. Typically the floor 115 is grounded and therefore serves as part of the return path for the bias RF power (current).

In addition to the bias power electrode (wafer support pedestal) 135, other RF power applicators may be employed that are beyond the scope of this disclosure. For example, the ceiling 110 may be insulated from the side wall 105 and another RF power generator (not shown) may be connected to the ceiling, so that the ceiling serves as a capacitively coupled source power applicator. Alternatively, the ceiling 110 may be formed of dielectric material and an overhead inductive antenna or coil (not shown) may be supported over the ceiling 110 and connected to another RF power generator. The present disclosure concerns the structure of the wafer support pedestal 135 which can be used with or without any or all of the foregoing alternatives.

Low Loss Coaxial RF Bias Power Feed:

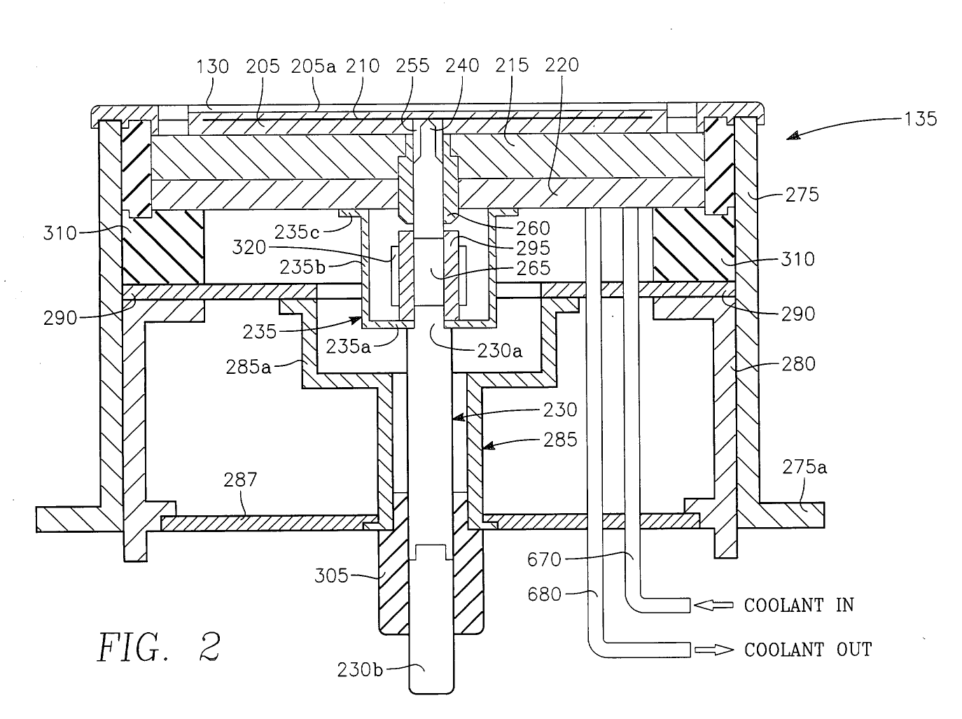

Referring to FIG. 1 and particularly referring to the enlarged view of the wafer support pedestal 135 of FIG. 2, the wafer support pedestal 135 consists of a dielectric layer or “puck” 205 and a buried electrostatic chuck (ESC) electrode 210 within the dielectric layer 205 and near the dielectric layer top surface 205a. The puck 205 is supported on a conductive ESC base 215. The ESC base 215 rests on a facilities plate 220 having coolant passages therethrough (not shown in FIGS. 1 and 2). The facilities plate 220 and the ESC base 215 can be formed of the same material, such as aluminum. As can be seen in the enlarged view of FIG. 2, the buried ESC electrode 210 cannot extend all the way to the edge of the dielectric layer or puck 205 because it must be encapsulated therein to enable it to hold the ESC charge. Therefore, if the ESC electrode 210 is connected to the bias power generator 150 as an RF bias power applicator in accordance with conventional practice, the electric field changes in magnitude and/or direction and becomes non-perpendicular over the portion of the wafer 130 outside of the outer edge of the ESC electrode 210. This gives rise to the dead zone around the wafer periphery in which production yield is poor, as mentioned earlier in this specification. This dead zone is quite large because the wafer 130 not only extends beyond the ESC electrode 210 to the edge of the puck 205 but actually extends well beyond the edge of the puck 205 so as to overhang the puck in order to provide better protection of the puck 205 against the plasma. In order to address this problem, the RF output of the impedance match element 155, in one embodiment, is not connected to the buried electrode 210 but rather to the bottom of the ESC base 215, i.e., to the facilities plate 220. Thus, the ESC base 215 dominates in capacitively coupling RF power to the plasma through the entire puck 205, rather than primarily through the ESC buried electrode 210 and the portion of the puck 205 above the plane of the ESC buried electrode 210. A principal advantage of this feature is that because the ESC base 215 extends well beyond the edge of the wafer 130, better capacitive coupling to the plasma can be provided at the wafer periphery. How this advantage can be more fully exploited will be explained below in a subsequent section of this specification.

In order to couple RF power directly from the impedance match element 155 to the facilities plate 220, an elongate bias transmission line inner conductor 230 extends from the RF power output of the impedance match element 155 at the bottom of the wafer support pedestal 135 nearly up to the facilities plate 220. The bias transmission line inner conductor 230 can be cylindrical and can be quite thick (e.g., 0.50 inch to 0.75 inch in diameter) to minimize RF losses. The top end 230a of the bias transmission line inner conductor 230 is below the level of the bottom surface of the facilities plate 220 (e.g., by about 0.5 to 2 inches). The connection between the bias transmission line inner conductor top end 230a and the facilities plate 220 is provided by a bias transmission line inner conductor terminator (BTLICT) 235. The BTLICT 235 is formed of a conductive material (e.g., aluminum) and consists of a planar disc 235a engaging the inner conductor top end 230a, a hollow cylinder 235b having a bottom edge engaging the disc 235a, and an annular top disk 235c engaging a top edge of the cylinder 235b. The annular top disk 235c is in firm contact with the bottom surface of the facilities plate 220. (While the ESC base 215 and facilities plate 220 are described as two distinct parts, they may in fact be combined into a single part.) The space inside the hollow cylinder 235b houses a conductive plug 240 extending to the buried ESC electrode 210 in an insulated passage 255 through the facilities plate 220, through the ESC base 215 and through the puck 205. A cylindrical dielectric sheath 260 surrounding the sides of the plug 240 insulates the plug 240 from the conductive facilities plate 220 and ESC base 215. As indicated schematically in FIG. 1, the ESC electrode 210 is connected through an RF filter choke 265 within the hollow cylinder 235b to an ESC voltage controller 270 outside the chamber that furnishes the chucking voltage to the ESC electrode 210. The choke 265 provides sufficient isolation of the ESC electrode 210 from the RF bias power if the choke inductance is sufficient to produce an impedance of between about 1 and 20 kOhms at the RF bias power generator frequency (e.g., 13.56 MHz).

The wafer support pedestal 135 is protected from plasma in the chamber or in the pumping annulus by a cylindrical metallic cathode liner 275 that is easily removed and replaced and extends along most of the height of the pedestal 135. The cathode liner 275 may be anodized aluminum, for example. A permanent cylindrical conductive cathode shield 280 covers the interior surface of the cathode liner 275. With only the features mentioned thus far in this description, the cathode shield 280 and/or the cathode liner 275 would function as the outer conductor of a coaxial transmission line whose inner conductor is the bias transmission line inner conductor 230. However, the large radius and surface area of the cathode liner 275 and/or cathode shield 280 would represent a very large inductive load, leading to great inefficiencies in delivering RF bias power to the plasma. The RF feed structure between the impedance match element 155 and the ESC base 215 or facilities plate 220 (or ESC electrode 210 if the RF connection is made to that plane) typically exhibits inductive behavior. In prior art apparatus where the radial gap between the inner conductor 230 and chamber shield 280 was large (no outer conductor 285 was present), the RF feed structure would exhibit a relatively large inductance due to the large “area loop” (the product of the feed structure length and the radial gap between inner and outer conductors) formed by the RF bias current path, including its return path. (As stated earlier, the bias power conductor length cannot simply be shortened to ameliorate the problem, because the pedestal height cannot be shortened without compromising the performance of the reactor.) The reason that the relatively high inductance of the RF feed structure is problematic is as follows: The RF impedance match element 155 typically has the circuit topology referred to as an “L” network, though the following discussion of losses still generally applies regardless of the topology of the impedance match used. An “L” network impedance match for matching a typical 50 ohm resistive impedance RF generator to an RC (resistive and capacitive) plasma load impedance with a real part of less than the 50 ohm resistive impedance of the RF generator has a variable parallel input capacitor and a series combination of an inductor and a capacitor, one of which is variable, connected between the input and output of the “L” network impedance match 155. The variable parallel input capacitor and the variable series capacitor or inductor are tuned together to match the plasma load impedance. But the plasma load impedance is not directly connected to the impedance match 155. The wafer support pedestal 135 is necessarily interposed between the impedance match 155 and the plasma load impedance. As stated earlier, the RF feed structure is typically inductive. Furthermore, an insulator ring 310 is necessary to separate and electrically isolate the ESC base 215 (and/or facilities plate 220) from ground (the chamber shield 280 and upper ground plane 290) in the case where the ESC base 215 (and/or facilities plate 220) are not grounded (e.g. RF power is applied thereto). This structure has a capacitance, which appears across the bias transmission line inner conductor top end 230a (which is connected to the facilities plate 220 and/or ESC base 215) and ground. An additional series capacitance is present across the ESC puck 205 between the ESC base 215 and the wafer 130. Thus the wafer support pedestal 135, which is interposed between the impedance match 155 and the wafer 130 (and thus the plasma), can be modeled as a “T” network, an electrical equivalent circuit consisting of: a first series input inductance (the RF feed structure), a shunt (parallel) capacitance to ground, and a series output capacitance (the ESC puck 205). The effect of a large first series input inductance (the RF feed structure) is to require the impedance match 155 to compensate with a complimentary large series capacitive reactance. This increases the voltage drops across each of the series elements in the match circuit (the inductor and capacitor) and across the inductance of the RF feed structure. It also increases the voltage at the impedance match output (and thus the input voltage to the RF feed structure) relative to ground. This increases the losses of any imperfect dielectric materials in the aforementioned components, namely the series output capacitor of the impedance match 155, any dielectric stand-offs used for mounting of matching components, the dielectric between the impedance match 155 output and ground, and the dielectric between the input of the RF feed structure and ground. Furthermore, where the radial gap between the inner conductor 230 and chamber shield 280 was large (no outer conductor 285 was present), other components may be necessarily present in that space, within that “area loop” formed by the RF bias current path, including its return path. These components may be comprised of, for example, stainless steel bellows that are part of a wafer lift-mechanism, stainless steel cooling gas lines, or other materials such as dielectric water lines or dielectric cooling gas feed-through devices. If these materials are imperfect dielectrics or imperfect conductors, they may be dielectrically heated due to the oscillating RF electric field within the “area loop”, or they may be inductively heated due to the oscillating RF magnetic field (due to eddy current or hysteresis losses).

In order to solve this problem, a bias transmission line outer conductor 285 having a relatively small radius surrounds the bias transmission line inner conductor 230 along much of its length. The diameter of the outer conductor 285 is at least near the minimum required to provide a sufficient gap between the inner and outer conductors 230, 285 to avoid arcing between them. The minimum gap to prevent arcing depends upon the amount of RF power delivered by the RF power generator. In one implementation, the gap between the inner and outer conductors 230, 285 was about 0.25 inch. By thus minimizing the diameter of the outer conductor 285, inductive loading along the transmission line is minimized. In other words, due to the relatively small radius and surface area of the bias transmission line outer conductor 285, the inductive load is greatly reduced and the efficiency with which bias RF power is delivered to the plasma is greatly enhanced. Both the top and bottom ends of the bias transmission line outer conductor 285 are grounded. The top end 285a of the outer conductor 285 is grounded by an upper planar metal annulus or ground plane 290 whose inner edge is connected to the top of the outer conductor 285 and whose outer edge is connected to the cathode shield 280. The bottom end of the outer conductor 285 is grounded by direct connection to the true RF ground of the RF return terminal of the impedance match 155, as indicated schematically in FIG. 1. Typically, the power terminal of the impedance match connected to the inner (or center) conductor 230 and the RF return terminal connected to the outer conductor 285 are coaxial terminals that mate respectively to the inner and outer conductors 230, 285. The RF return terminal of the impedance match 155 is the terminal with the ground symbol connected to the outer conductor 285. The RF power terminal of the impedance match 155 is the terminal connected to the inner conductor 230.

Thus, the outer conductor 285 can be grounded at both ends of the RF feed structure between the impedance match element 155 and the ESC base 215 or facilities plate 220 (or ESC electrode 210 if the RF connection is made to that plane) and the radial gap between inner conductor 230 and outer conductor 285 may be small. Such an optional arrangement reduces the size of the “area loop” formed by the RF bias current path, including its return path. This substantially reduces the inductance of the RF feed structure without compromising the performance of the reactor. The low inductance transmission line structure thus formed confines within itself the oscillating electric and magnetic fields generated by the coupling therethrough of RF bias power and is so efficient and exhibits such low RF noise or RF radiation that the lower ground plane 287 can be omitted if desired without significant RF radiation leakage to other parts of the reactor or instrumentation therein. Furthermore, losses due to RF heating of other components (mentioned earlier, such as stainless steel bellows that are part of a wafer lift-mechanism, stainless steel cooling gas lines, or other materials such as dielectric water lines or dielectric cooling gas feed-through devices) that are necessarily present within the wafer support pedestal 135 but are outside the outer conductor 285, can be virtually eliminated due to the self-confinement of the oscillating electric and magnetic fields within the transmission line structure.

It should be noted that the top of the outer conductor 285 is only indirectly connected to the true ground potential present at the RF return terminal of the impedance match 155 via the upper annular ground plane 290, and is therefore not connected directly to it. Nevertheless, as understood in this specification, such an indirect connection to the true ground potential (e.g., via a grounded chamber component) is referred to herein as coupling to a ground potential.

For containing or shielding radiation that would otherwise emanate from within the wafer support pedestal 135, a lower annular conductive ground plane 287 is provided whose inner edge is connected to the bottom of the outer conductor 285 and whose outer edge is connected to the cathode shield 280.

The cathode liner 275 is connected to the wafer support pedestal 135 or to the bottom of the chamber 155 using a minimum number of fasteners so that it can be speedily replaced as a consumable of the chamber. Therefore, the cathode liner 275 does not necessarily provide good RF contact along its length and is not directly connected to the upper ground plane 290 in the reactor of FIG. 2. Therefore, the return path of the bias power (current) from the plasma back to the ground terminal of the RF impedance match element 155 begins with RF current being coupled across the plasma sheath to the grounded ceiling 110 and/or side wall 105 and downward to the chamber floor 115 and across to the bottom of the cathode liner 275. The current then flows upwardly along the outside surface of the cathode liner 275 to the top and then down the inside surface of the cathode line 275 to the bottom of the cathode shield 280. The current then flows up the outside surface of the cathode shield 280 to the upper ground plane 290, and thence down the inside surface of the outer conductor 285 to the ground terminal of the RF impedance match element 155. From the foregoing, it is seen that one purpose of the cathode shield 280 is to provide good RF contact for the upper ground plane 290.

In the implementation illustrated in FIG. 2, the diameter of the hollow interior of the BTLICT 235 is sufficiently large to accommodate the plug 240 and a plastic supporter 295 supporting the plug 240. The plastic supporter 295 insulates the conductive plug 240 from the inner conductor 230. The outer conductor 285 has an inner diameter only 0.25 inch greater than the diameter of the inner conductor 230 for most of its length, with the exception of a top section 285a of the top conductor 285. The top section 285a has a larger diameter to accommodate the plastic supporter 295 and the conductive plug 240. The plastic supporter 295 can have a low dielectric constant and a high breakdown voltage, in which case it is formed of a suitable plastic material.

A bottom portion 230b of the inner conductor 230 extends below the floor of the chamber to be received in a female connector constituting the RF output of the impedance match element 155. A teflon insulator 305 separates the inner conductor 230 from the outer conductor 285 and lower ground plane 287 and adjacent conductive elements.

A low capacitance insulator ring 310 supports the facilities plate 220 on the upper ground plane 290 and provides a separation therebetween. The insulator ring 310 has a low dielectric constant, low dielectric loss factor, a high breakdown voltage and suitable vacuum-compatible characteristics and is formed of a suitable plastic such as polystyrolene. Typically the insulator ring 310 has a thickness of about 0.75 to 2 inches. The low capacitance of the insulator ring 310 minimizes power loss that might occur by capacitive coupling between the ESC base 215 and the upper ground plane 290. The low capacitance of the insulator ring 310 also minimizes losses by reducing RF current requirement from the impedance match 155. The reason for this is as follows: The insulator ring 310 is necessary to separate and electrically isolate the ESC base 215 (and/or facilities plate 220) from ground (the chamber shield 280 and upper ground plane 290) in the case where the ESC base 215 (and/or facilities plate 220) are not grounded (e.g. RF power is applied thereto). Prior art apparatus used a plastic insulator ring with small thickness (e.g. 0.5 inch), higher dielectric constant and higher loss factor. Some prior art apparatus used ceramic, which may have even higher dielectric constant and loss factor. In one implementation of this invention, a thick (0.75 to 2 inch) insulator ring is used, with low dielectric constant (<3) and low loss factor. This reduces losses several ways. First, the insulator ring itself exhibits lower dielectric losses due to the reduced RF electric field (due to the greater thickness), lower dielectric constant and lower loss factor. Second, the reduced capacitance of the ring reduces the current requirement that the impedance match element 155 must provide to drive a given plasma load impedance, since the insulator ring 310 is electrically in parallel with the plasma load impedance. Reducing the current requirement that the impedance match element 155 must provide reduces ohmic (I²R) losses in both the impedance match element 155 (mostly within the series inductive coil) and within the RF feed structure.

Together, the inductive RF feed structure and the capacitance of the insulator ring 310 form a series LCR (inductive and capacitive circuit with a resistive loss component) circuit. This series RLC circuit will resonate at a resonant frequency determined by the inductance and the capacitance. In typical prior art apparatus for processing of 12″ diameter wafers, the RF feed structure inductance may be about 200 nanohenries and the insulating ring capacitance may be about 500 picofarads, yielding a series resonant frequency of about 16 MHz. In this invention, the RF feed structure inductance may be about 50 nanohenries and the insulating ring capacitance may be about 200 picofarads, yielding a series resonant frequency of about 50 MHz. If the RF bias frequency is 13.56 MHz, the performance of the prior art reactor may be compromised due to the harmonics of the fundamental RF bias frequency generated in the non-linear plasma sheath interacting with the RF feed structure and insulating ring capacitance. If the series resonant frequency of the RF feed structure and insulating ring capacitance is less than or approximately equal to the frequency of a harmonic of the RF bias frequency where significant energy (voltage or current) is present in the plasma sheath, then the behavior of the plasma sheath may be affected by the RF feed structure and insulating ring capacitance. For example, the ion energy distribution at the wafer, an important process parameter affecting etching or deposition characteristics, may be changed. In a typical process using this invention, significant energy (voltage or current) may be present in the plasma sheath at the 2^{nd} and 3^{rd} harmonic of the 13.56 MHz RF bias frequency (e.g. 27.12 MHz and 40.68 MHz). In this invention, the RF feed structure inductance and insulating ring capacitance have a series resonant frequency of about 50 MHz, well above the 2^{nd} and 3^{rd} harmonics of the 13.56 MHz RF bias frequency. The RF feed structure inductance and insulating ring capacitance thus do not adversely affect the behavior of the plasma sheath harmonics or the resultant ion energy distribution at the wafer.

Other losses are minimized by the cathode liner 275 because the conductive cathode liner 275 terminates radial electric fields originating inside the wafer support pedestal 135 that might otherwise couple to plasma in the pumping annulus.

As mentioned above, the small diameter of the outer conductor 285 and the correspondingly small clearance between the inner and outer conductors 230, 285 minimize the inductance along the current path from the impedance match element 155 to the cathode base 215. By thus minimizing the inductance, the Q of the load can be minimized and the resonant frequency can be increased above, for example, the third harmonic of the RF bias frequency generator. Raising the resonant frequency along the coaxial transmission line constituting the inner and outer conductors 230, 285 causes this path to present a higher impedance to plasma sheath harmonics, and therefore tends to minimize interactions between plasma sheath harmonics and wafer support pedestal 135. This improves process performance because interactions between harmonics of the fundamental RF bias frequency generated in the non-linear plasma sheath can interact with the aforementioned resonances in the wafer support pedestal 135, changing plasma sheath characteristics (e.g., ion energy distribution) and/or leading to power losses.

An advantage of the small diameter of the outer conductor 285, and the low inductance associated with it, is the low loss in the RF bias current path through the transmission line constituting the inner and outer conductors 230, 285. A related advantage is that the coaxial transmission line structure thus provided contains the RF fields so that there is little or no radiation of RF power outside of the outer conductor 285. Thus, the structure provides low power loss and a very low noise environment.

One optional feature is that reactive elements 320 may be mounted on the insulator support 295 for connection between the inner conductor 230 and the conductive plug 240 connected to the ESC electrode 210. Selection of the reactances of the reactive elements 320 controls the ratio between the RF voltages on the inner conductor 230 and the puck 205. These reactances can be chosen, for example, to achieve a high impedance to harmonics of the RF generator 150 (i.e., to isolate plasma sheath harmonics from the wafer support pedestal 135). Another option is to connect the inner conductor 230 directly to the conductive plug 240, rather than to the ESC base 215, leaving the base 215 at a floating potential. A further option would be to ground the ESC base 215. However, the currently preferred implementation is the one first described above, in which the inner conductor 230 is connected to only the ESC base 215 via the facilities plate 220, since this implementation provides certain advantages. One advantage of such an implementation is that the RF potential of the ESC base is maximum, because the RF current is carried capacitively through the entire puck 205, rather than primarily through the ESC electrode 210 and the portion of the puck 205 above the plane of the ESC electrode 210, which allows the ESC base 215 to enhance capacitive coupling of bias power to plasma at the wafer periphery in a manner to be described in the next section of this specification.

RF Powered Process Kit:

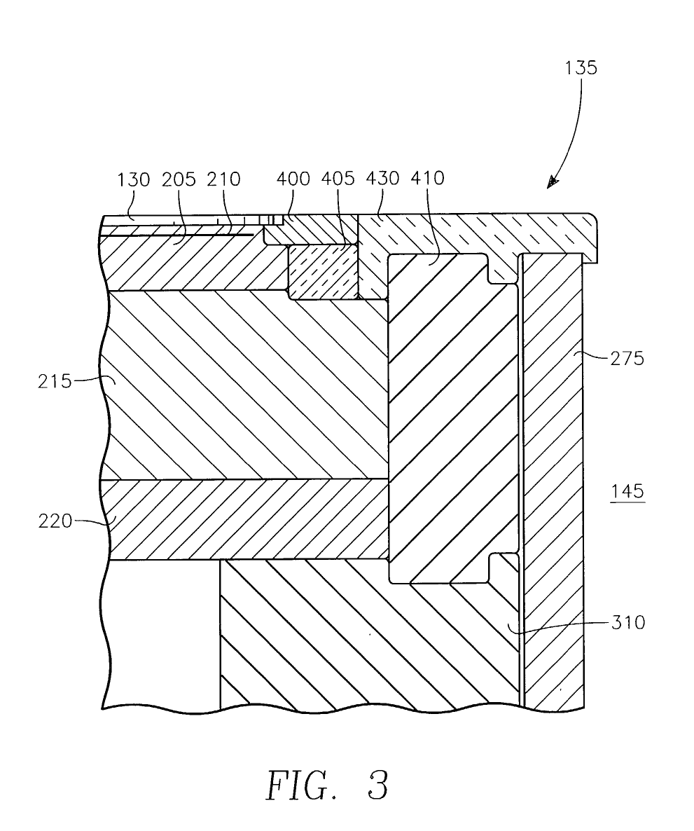

FIG. 3 is an enlarged view of an upper corner of the wafer support pedestal 135 of FIG. 2. The edge of the wafer 130 and the portion of the wafer 130 overhanging the puck 205 is nested in a shoulder of a collar 400 consisting of a process-compatible material. Such a process compatible material may be silicon, silicon carbide or quartz for a silicon dioxide etch process for example. For an aluminum etch process, a process compatible material would be alumina or aluminum nitride for example. If the collar is quartz, then it has a dielectric constant of about 4. The collar 400 can have an axial thickness about one-third the thickness of the puck 205. The collar 400 rests on a high capacitance RF coupling ring 405 whose thickness is about two-thirds of the puck 205, so that the collar 400 and the ring 405 surround the entire puck 205. The high capacitance RF coupling ring 405 may be formed of a ceramic material so as to have a very high dielectric constant, such as about 9. In order to block plasma penetration to the ESC base 215, the collar 400 extends radially inwardly from the wafer edge and radially outwardly from the outer edge of the ring 405. The dielectric constant of the ceramic ring 405 is high (e.g., typically greater than or equal to than that of the puck 205) so that the ceramic ring 405 provides high capacitive coupling of RF bias power from the ESC base 215 to the plasma over the wafer periphery. The radial thickness of the ring 405, the axial thickness of the ring 405 and its dielectric constant are selected to provide sufficient enhancement of capacitive coupling to the plasma over the wafer periphery to overcome the problems of poor process performance near the wafer periphery. This feature is facilitated by the ESC base 215 underlying the ring 405 being directly driven with RF bias power, as described above with reference to FIG. 2. In order to avoid losses to plasma in the pumping annulus, an annular quartz spacer 410 provides radial displacement between the metal ESC base 215 and the metal cathode liner 275. The spacer 410 can be formed of quartz and fills in the void between the ESC base 215 and the cathode liner 275. Such a void would otherwise fill with gas that might become ionized. To avoid such internal plasma ignition in various parts of the wafer support pedestal 135, all of the gaps between adjoining structural elements (for example, the gaps between the ESC base 215, the spacer 410 and the cathode liner 275) are smaller than the plasma sheath thickness.

Thus, the high dielectric constant of the ceramic ring 405 provides greater capacitive coupling of RF power from the ESC base 215 to plasma overlying the wafer periphery. The effective capacitance per unit area near the wafer pedestal will be the series combination of the capacitances per unit area of the ceramic ring (a large capacitance) and of the collar 400 (a smaller capacitance). By thus increasing the electric field over the wafer periphery, the problems encountered at the wafer periphery in conventional reactors, such as poor etch profile due to non-perpendicular electric fields, poor etch rate and depth, tendency toward etch stopping in high aspect ratio openings

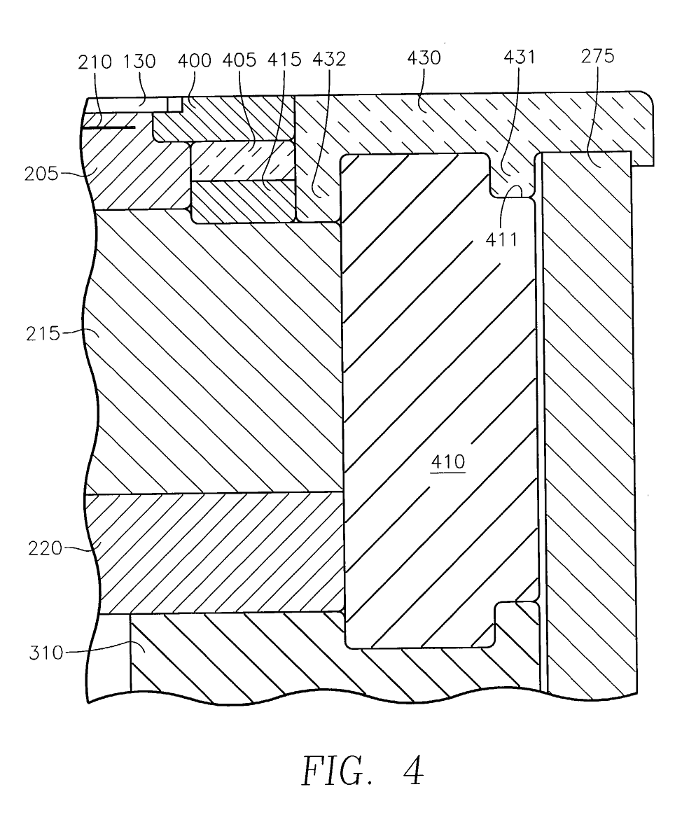

The degree to which the capacitive coupling of RF power from the ESC base 215 to plasma over the wafer periphery needs to be enhanced can be determined empirically for each process that is to be performed. This need can arise from a number of factors. For example, the portion of the wafer 130 overhanging the edge of the puck 205 overlies the silicon (or silicon carbide) collar but is separated therefrom by an air gap of about 3 to 7 mils, the air gap having relatively low dielectric constant (e.g., 1). This aspect suppresses capacitive coupling of RF power to plasma over the peripheral portion of the wafer 130. The needed increase in capacitive coupling at the wafer periphery may be determined on the basis of the radial distribution of etch rate, or the radial distribution of etch profile, or other parameters, for example. Once the determination is made, the capacitive coupling by the ceramic ring 405 that provides the requisite enhancement can be found for example by trial and error, or possibly by analytical methods. This capacitive coupling of the ring 405 can be controlled by appropriate selection of the dielectric constant of the ceramic ring 405, of the axial thickness of the ceramic ring 405 and of the radial thickness of the axial ring 405. The axial thickness can be greatly reduced from that illustrated in FIG. 3. For example, FIG. 4 illustrates a case in which the axial thickness of the ceramic ring 405 has been reduced to such an extent that an aluminum filler ring 415 is employed to fill the void left by reduction of the axial thickness of the ceramic ring 405.

A low capacitance quartz cover 430 (dielectric constant of about 4) overlies the quartz spacer 410 and the cathode liner 275. The quartz spacer 410 has a first leg 431 nesting in an outer corner 411 of the quartz spacer 410 and a second leg 432 extending axially between the quartz spacer 410 on one side and the collar 400 and ring 405 on the other side. A portion of the second leg 432 extends below an outer portion of the collar 400, so that the gap between the cover 430 and the components 275, 410, 215 underlying it meanders to prevent plasma leakage therethrough. It should be noted that this approach is followed throughout the design of the entire wafer support pedestal 135, so that contiguous air (or vacuum) gaps or passages tend to meander in order to suppress plasma leakage and promote recombination.

In summary, the radial and axial thicknesses of the ceramic ring 405 and its dielectric constant are selected to achieve a radial distribution of capacitance per unit area over the aluminum ESC base 215 that is sufficiently greater at the periphery than at the center to compensate for inherent factors that would otherwise tend to distort process performance. For example, the capacitance per unit area provided by the ceramic ring 405 is sufficiently greater than that of the ESC puck 205 so as to achieve a more nearly uniform radial distribution of etch rate or etch profile, for example. Since the ESC base 215 is driven with the bias RF power generator, it is spaced from the grounded cathode liner 275 by the quartz spacer 410 and by the insulator ring 310 from the upper ground plane 290. The spacing provided by the quartz spacer 410 is sufficiently large and the dielectric constant of the quartz spacer 410 is sufficiently small to avoid or prevent arcing and/or gas breakdown between the base 215 and the liner 275. The spacing provided by the insulator ring 310 is sufficiently large and the capacitance of the insulator ring 310 is sufficiently small to avoid or prevent arcing and/or gas breakdown between the base 215/facilities plate 220 and the upper ground plane 290.

The RF potential of the ESC base 215 with respect to the ESC electrode 210 is governed by the manner in which it is coupled to the RF power output of the impedance match element 155. In one case, it is connected directly to the RF power output and is therefore at maximum RF potential. In another case, optional reactive elements are connected between the ESC base 215 and the ESC electrode 210 so that the RF potential is divided between the ESC electrode 210 and the ESC base 215. This latter option reduces the RF potential on the ESC base 215 and therefore reduces the amount of RF power that can be coupled from the ESC base 215 via the ceramic ring 405 to plasma at the wafer periphery to compensate for roll-off of the electric field beyond the edge of the puck 205.

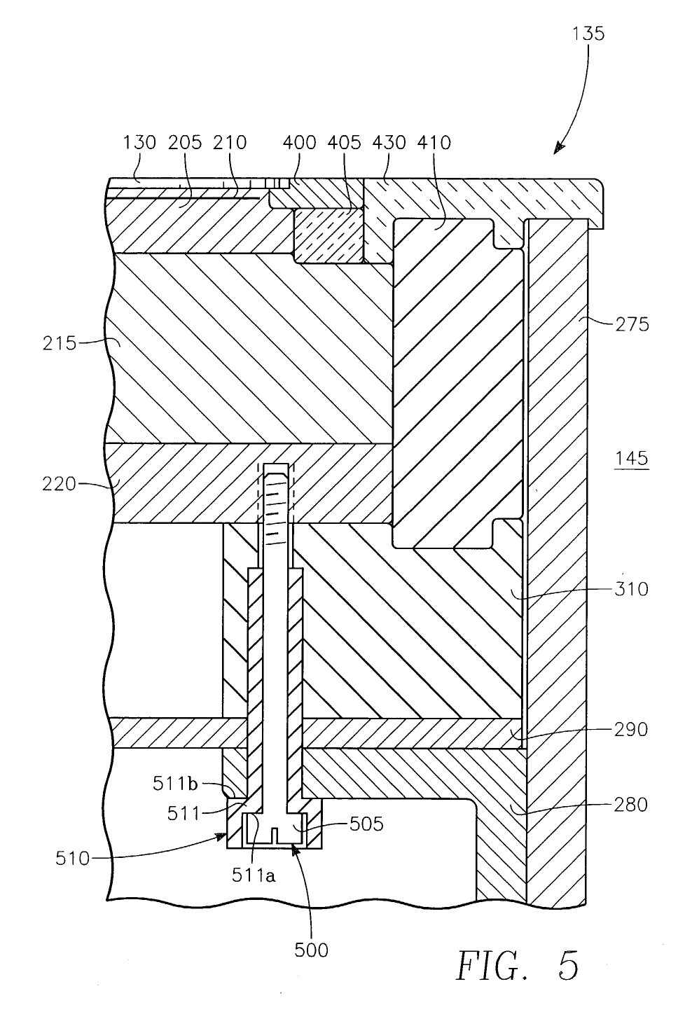

FIG. 5 illustrates how the ESC base 215 and the upper ground plane 290 can be fastened together without shorting the ground potential of the upper ground plane 290 to the RF-driven ESC base 215. Specifically, a metal screw 500 with a head 505 is insulated from the cathode shield 280 and from the upper ground plane 290 by a low dielectric constant (and low loss), high breakdown voltage sleeve 510 having a shoulder 511 whose bottom surface 511a engages the screw head 505 and whose top surface 511b engages the bottom surface of the cathode shield 280. The top end of the screw is threadably engaged in the bottom of the facilities plate 220 and holds the insulator ring 310 and upper ground plane 290 in compressive tension. A low loss high breakdown voltage material that may be used for the sleeve 510 is polystyrolene, for example.

Two-Layer Parallel Path Coolant Distribution Plate:

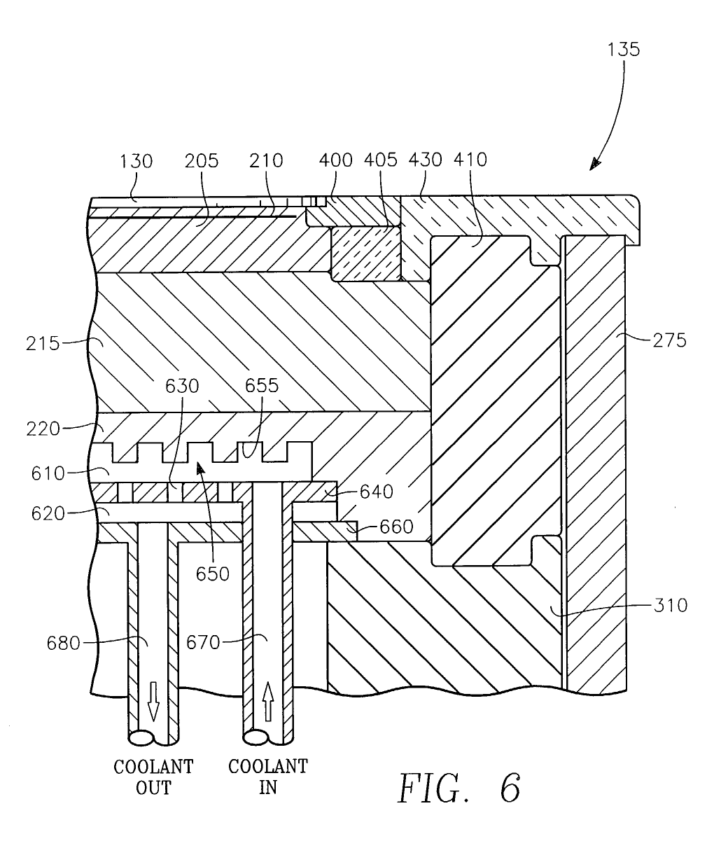

FIG. 6 is a cut-away cross-sectional view of a portion of the facilities plate 220 of FIGS. 1 and 2. The facilities plate 220 of FIG. 6 overcomes the problems associated with conventional serpentine path coolant plates of low flow rates, thermal loading and non-uniform temperature distribution. The problem of low flow rates arises from the small cross-sectional area of the serpentine coolant passages. The problem of thermal loading of the coolant arises from the warming of the coolant as it travels a long thin passage. The problem of non-uniform temperature distribution of the wafer arises from the other two problems.

In the facilities plate 220 of FIG. 6, numerous parallel paths of the coolant are provided to solve the problem of thermal loading, the paths riot being as restricted in cross-sectional area to solve the problem of low flow rates. In conventional coolant plates, all coolant flow is in a plane parallel to the wafer 130. In the facilities plate of FIG. 6, a pair of coolant manifolds 610, 620 are provided and coolant flow occurs in the axial direction between the two manifolds 610, 620 through plural passages 630. The multi-passage coolant flow in the axial direction between the manifolds 610, 620 constitutes parallel path coolant flow. Such parallel path flow solves the problem of thermal loading characteristic of the serial flow patterns of convention techniques. Moreover, the total cross-sectional area provided by the multiple passages is many times greater (than that of serial passages of the prior art), which solves the problem of low flow rates.

Referring now to FIG. 6, the upper coolant manifold 610 is defined by an intermediate wall 640 and a top wall 650. The bottom-facing surface of the top wall has many small square holes 655 formed therein to maximize exposed surface area. The small square holes 655 may be about 1 mm deep and about 1 mm in lateral extent, for example. The holes 655 in the implementation of FIG. 6 are configured in a periodic array to form a “waffle” pattern. The plural coolant passages 630 are formed in the intermediate wall 640. The lower coolant manifold 620 is defined by the intermediate wall 640 and a floor 660. An coolant input conduit 670 extends through the floor 660 and through the intermediate wall 640 and opens into the upper coolant manifold 610. An external coolant output conduit 680 extends through the floor 660 and opens into the lower coolant manifold 620. Refrigerated coolant is injected into the input conduit 670 and fills the upper manifold 610. It conducts heat away from the waffled top wall 650 by flowing downwardly through the many parallel passages 630 in the intermediate wall 640 to fill the lower manifold 620. The coolant is extracted from the lower manifold 620 through the output conduit 680. The input and output conduits 670, 680 extend downwardly through the floor of the wafer support pedestal 135, as shown in FIG. 2. Since the input and output conduits 670, 680 extend in the axial direction, they may be of a large cross-sectional area, in order to promote high fluid flow rates. The effective cross-sectional area of the fluid flow between the two manifolds 670, 680 is the sum of the cross-sectional areas of all of the parallel passages 630, so that fluid flow occurs through a large effective cross-sectional area for maximum flow rate for a given pumping pressure, a significant advantage. As a result, a highly uniform temperature distribution across the wafer 130 is realized, with proportionately superior process results.

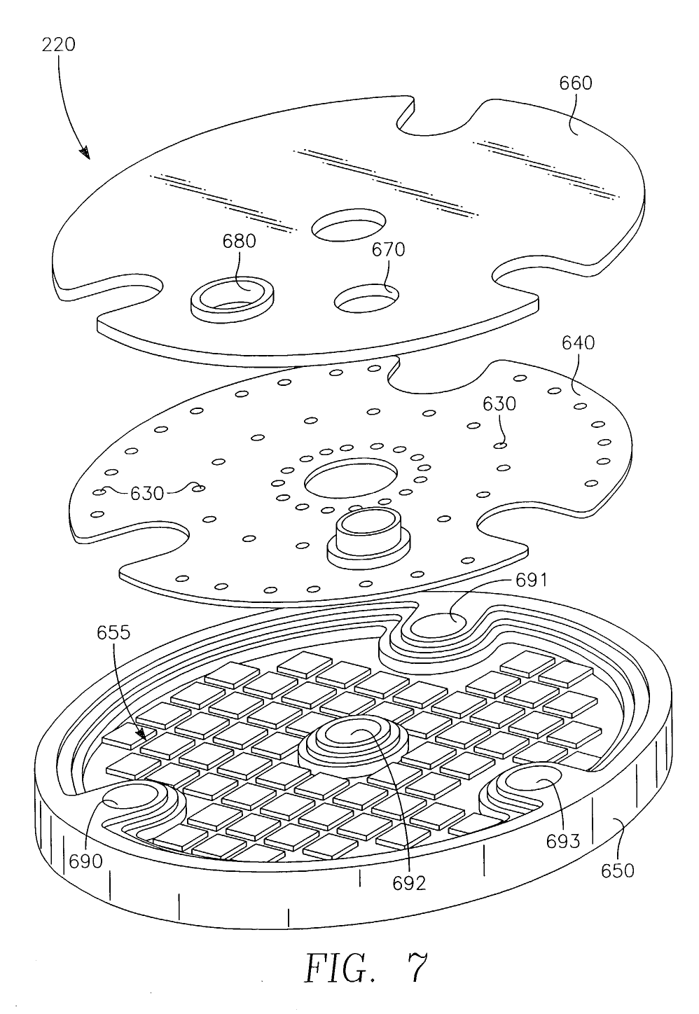

FIG. 7 is an exploded bottom perspective view of the facilities plate 220 of FIG. 6. It shows that the facilities plate 220 accommodates various conduits therethrough, namely conduits 690, 691, 692, 693 for other utilities that must pass through the ESC base 215, including a helium supply for the wafer-puck interface, an ESC chuck voltage conductor and the bias power transmission line inner conductor 230.

While the invention has been described with reference to an RF power source that includes the RF power generator 150 and the impedance match 155, any suitable RF power source that includes at least an RF generator may be employed. Thus, the term RF power source is understood herein to refer to apparatus including at least an RF generator and possibly an impedance match at the output of the RF generator.

While the invention has been described in detail by specific reference to preferred embodiments, it is understood that variations and modifications thereof may be made without departing from the true spirit and scope of the invention.

What is claimed is:

1. In a plasma reactor for processing a semiconductor wafer having a wafer diameter within a vacuum chamber of said reactor, a wafer support pedestal in said vacuum chamber extending upwardly from a floor of said vacuum chamber, said wafer support pedestal comprising:
a top layer having a generally planar surface for supporting said wafer, said top layer having a diameter on the order of said wafer diameter;
a conductive base underlying and supporting said top layer, said conductive base having a diameter at least as great as said wafer diameter;
RF power output and return terminals below the floor of said vacuum chamber and an RF power source connected across said output and return terminals;
an elongate inner conductor generally parallel to an axis of said conductive base, said elongate inner conductor having a bottom end connected to said RF power output terminal and a top end terminated at one of (a) said conductive base and (b) said top layer;
a hollow cylindrical outer conductor coaxial with said inner conductor, said hollow cylindrical outer conductor being separated from said elongate inner conductor by a coaxial gap and having a bottom end connected to said RF power return terminal;
a conductive upper ground plane annulus generally coaxial with said inner and outer conductors and located in a plane near said top end of said inner conductor, said conductive upper ground plane annulus having an inner edge connected to an upper end of said hollow cylindrical outer conductor and an outer edge coupled to a ground potential.

2. The apparatus of claim 1 further comprising an insulating ring of low capacitance and high breakdown voltage material between said conductive base and said upper ground plane.

3. The apparatus of claim 2 wherein said insulating ring provides sufficient axial separation between said conductive base and upper ground plane and sufficiently low capacitance therebetween to minimize RF coupling therebetween and avoid arcing therebetween.

4. The apparatus of claim 1 or 2 wherein said coaxial gap is a fraction of a diameter of said elongate inner conductor.

5. The apparatus of claim 1 or 2 wherein said coaxial gap is on the order of a threshold below which arcing across said gap can occur.

6. The apparatus of claim 1 or 2 wherein said elongate inner conductor has a diameter of between about 0.50 inch and 0.75 inch and said coaxial gap is on the order of about 0.25 inch.

7. The apparatus of claim 1, further comprising:
a conductive lower ground plane annulus generally coaxial with said inner and outer conductors and located in a plane near said bottom end of said inner conductor, said conductive lower ground plane annulus having an inner edge connected to said hollow cylindrical outer conductor and an outer edge and coupled to a ground potential.

8. The apparatus of claim 1 further comprising:
an annular collar assembly surrounding said top layer and extending radially beyond the diameter of said top layer; and
a hollow cylindrical liner wall extending downwardly from a circumferential edge of said annular collar assembly at least nearly to the bottom of said wafer support pedestal.

9. The apparatus of claim 8 further comprising a low capacitance spacer ring disposed radially between said conductive base and said liner wall, said low capacitance spacer ring providing sufficient radial separation between said conductive base and said liner wall and sufficiently low capacitance therebetween to minimize RF coupling therebetween and avoid arcing therebetween.

10. The apparatus of claim 1 further comprising:
a cathode shield which is cylindrical, hollow and conductive, said cathode shield being adjacent an inner surface of said cathode liner wall, said cathode shield being connected to an RF ground potential;
the outer edge of said upper ground plane being coupled to a ground potential by being connected to said cathode shield.

11. The apparatus of claim 1 wherein said top layer is insulating, said reactor further comprising:
a thin planar conductive electrostatic chuck electrode enclosed inside said top layer;
a conductive chuck electrode connector connected to said chuck electrode and extending downwardly from said chuck electrode through said top layer and through said conductive base and having a connector end below said conductive base.

12. The apparatus of claim 11 further comprising:
a reactive element assembly connected between said elongate inner conductor and said conductive chuck electrode connector.

13. The apparatus of claim 12 wherein said reactive element assembly is supported on said insulating support.

14. The apparatus of claim 12 wherein said reactive element assembly provides a low impedance at the frequency of said RF power generator whereby to decrease a difference between RF potentials of said conductive base and electrostatic chuck electrode.

15. The apparatus of claim 12 wherein said reactive element assembly provides a high impedance at the frequency of said RF power generator whereby to increase a difference between RF potentials of said conductive base and electrostatic chuck electrode.

16. The apparatus of claim 1 wherein the diameter of said hollow outer conductor is sufficiently small to provide a high impedance at one or more harmonics of the frequency of said RF power generator, whereby to isolate plasma sheath harmonics.

17. The apparatus of claim 11 wherein said top end of said elongate inner conductor is terminated at a bottom surface of said conductive base and is electrically connected thereto, whereby said conductive base is RF-driven.

18. The apparatus of claim 11 wherein said top end of said elongate inner conductor is terminated within said top layer and is electrically connected to said electrostatic chuck electrode.

19. The apparatus of claim 18 wherein said conductive base has an RF potential that is one of (a) floating and (b) grounded.

20. The apparatus of claim 17 further comprising:
an annular collar assembly surrounding said top layer and extending radially beyond the diameter of said top layer, wherein said collar assembly comprises a low capacitance material; and
an RF coupling ring comprising a high capacitance material underlying a portion of said collar assembly near an inner radius of said collar assembly, said high capacitance ring overlying at least a peripheral portion of the RF-driven conductive base, whereby to capacitively couple RF power from said conductive base to a zone of said vacuum chamber overlying a peripheral portion of said wafer.

21. The apparatus of claim 20 wherein said high capacitance material has a dielectric constant approximately double that of said low capacitance material.

22. The apparatus of claim 21 wherein said high capacitance material has a dielectric constant of about 9 and said low capacitance material has a dielectric constant of about 4.

23. The apparatus of claim 20 wherein said high capacitance material has a large dielectric constant and said low capacitance material has a low dielectric constant, the difference between said high and low dielectric constants being sufficient to compensate for edge effects in the plasma near the periphery of the wafer.

24. The apparatus of claim 23 wherein said difference is sufficient to provide a more uniform radial distribution of etch rate over the surface of the wafer.

25. The apparatus of claim 20 wherein said collar assembly further comprises:
an inner annulus adjacent an edge of the wafer comprising a process-compatible material;
an outer annulus surrounding said inner annulus comprising a low capacitance insulating material.

26. The apparatus of claim 25 further comprising
a hollow cylindrical liner wall extending downwardly from a circumferential edge of said annular collar assembly at least nearly to the bottom of said wafer support pedestal, wherein said outer annulus of said collar overlies a top edge of said liner wall.

27. The apparatus of claim 20 wherein the diameter of said top layer is less than the diameter of said wafer whereby said wafer overhangs said top layer, said collar assembly having a portion thereof underlying the portion of the wafer overhanging said top layer, said portion of said collar assembly being separated from said wafer by a vacuum gap, whereby capacitive coupling across a peripheral portion of said wafer is impeded by said vacuum gap.

28. The apparatus of claim 27 wherein the difference between said high and low dielectric constants is sufficient to compensate for the impeding of the capacitive coupling across a peripheral portion of the wafer by said vacuum gap.

29. The apparatus of claim 20 further comprising a conductive ring underlying said RF coupling ring, whereby said RF coupling has an axial thickness less than that of said conductive base.

30. The apparatus of claim 1 wherein said conductive base comprises:
an upper coolant manifold having a generally planar extent and located at a first axial location;
a lower coolant manifold having a generally planar extent corresponding to the planar extent of said upper coolant manifold and located a a second axial location below the axial location of said upper coolant manifold;
an intermediate wall separating said upper and lower coolant manifolds and defining a ceiling of said lower coolant manifold and a floor of said upper coolant manifold;
a top wall overlying said intermediate wall and defining a ceiling of said upper coolant manifold;
a bottom wall underlying said intermediate wall and defining a floor of said lower coolant manifold;
a first external conduit connected through said bottom wall to said lower coolant manifold;
a second external conduit passing through said bottom wall and connected through said intermediate wall to said upper coolant manifold;
plural parallel passages in said intermediate wall for coolant flow between said upper and lower coolant manifolds; and
a coolant pump output port connected to an output end of one of said first and second external conduits and a coolant pump return port connected to another one of said first and second external conduits.

31. The apparatus of claim 30 further comprising plural holes in the bottom surface of said top wall whereby to increase surface area contacting coolant in said upper manifold.

32. The apparatus of claim 30 wherein said plural holes comprise a periodic array of square holes.

33. The apparatus of claim 32 wherein each of said square holes has a depth on the order of about 1 mm and a lateral extent on the order of about 1 mm.

34. The apparatus of claim 2 wherein said insulating ring of sufficiently low capacitance and said inner and outer conductors provide a-sufficiently low inductance so as to present a high impedance path to ground to plasma sheath harmonics.

35. The apparatus of claim 2 wherein:
said RF power source has a power source frequency;
said insulating ring is of a sufficiently low capacitance and said inner and outer conductors provide a sufficiently low inductance so as to form a resonance at a resonant frequency at least above said power source frequency.

36. The apparatus of claim 35 wherein said resonant frequency is above a second harmonic of said power source frequency.

37. The apparatus of claim 35 wherein said resonant frequency is above a third harmonic of said power source frequency.

38. The apparatus of claim 35 wherein said resonant frequency is above a fourth harmonic of said power source frequency.

39. In a plasma reactor for processing a semiconductor wafer having a wafer diameter within a vacuum chamber of said reactor, a wafer support pedestal in said vacuum chamber extending upwardly from a floor of said vacuum chamber, said wafer support pedestal comprising:
a top layer having a generally planar surface for supporting said wafer, said top layer having a diameter less than said wafer diameter;
a conductive base underlying and supporting said top layer, said conductive base having a diameter exceeding said wafer diameter;
an annular collar assembly surrounding said top layer and extending radially beyond the diameter of said top layer;
an RF power output terminal below the floor of said vacuum chamber;
an RF bias conductor connecting said RF power output terminal to said conductive base, whereby said conductive base is RF-driven;
an RF coupling ring comprising a high capacitance material underlying a portion of said collar assembly near an inner radius of said collar, said high capacitance ring overlying at least a peripheral portion of the RF-driven conductive base, whereby to capacitively couple RF power from said conductive base to a zone of said vacuum chamber overlying a peripheral portion of said wafer.

40. The apparatus of claim 39 wherein said collar assembly comprises a low capacitance material.

41. The apparatus of claim 40 wherein said high capacitance material has a dielectric constant approximately double that of said low capacitance material.

42. The apparatus of claim 40 wherein said high capacitance material has a dielectric constant of about 9 and said low capacitance material has a dielectric constant of about 4.

43. The apparatus of claim 40 wherein said high capacitance material has a large dielectric constant and said low capacitance material has a low dielectric constant, the difference between said high and low dielectric constants being sufficient to compensate for edge effects in the plasma near the periphery of the wafer.

44. The apparatus of claim 43 wherein said difference is sufficient to provide a more uniform radial distribution of etch rate over the surface of the wafer.

45. The apparatus of claim 39 wherein said collar assembly comprises:
an inner annulus adjacent an edge of the wafer comprising a process-compatible material;
an outer annulus surrounding said inner annulus comprising a low capacitance insulating material.

46. The apparatus of claim 45 further comprising:
a hollow cylindrical liner wall extending downwardly from a circumferential edge of said annular collar assembly at least nearly to the bottom of said wafer support pedestal;
wherein said outer annulus of said collar overlies at top edge of said liner wall.

47. The apparatus of claim 39 further comprising:
a hollow cylindrical liner wall extending downwardly from a circumferential edge of said annular collar assembly at least nearly to the bottom of said wafer support pedestal;
a low capacitance spacer ring disposed radially between said conductive base and said liner wall, said low capacitance spacer ring providing sufficient radial separation between said conductive base and said liner wall and sufficiently low capacitance therebetween to minimize RF coupling therebetween and avoid arcing therebetween.

48. The apparatus of claim 39 further comprising:
a hollow cylindrical conductive liner wall extending downwardly from a circumferential edge of said annular collar assembly at least nearly to the bottom of said wafer support pedestal.

49. The apparatus of claim 39 wherein said wafer overhangs said top layer, said collar assembly having a portion thereof underlying the portion of the wafer overhanging said top layer, said portion of said collar assembly being separated from said wafer by an vacuum gap, whereby capacitive coupling across a peripheral portion of said wafer is impeded by said vacuum gap.

50. The apparatus of claim 49 wherein the difference between said high and low dielectric constants is sufficient to compensate for the impeding of the capacitive coupling across a peripheral portion of the wafer by said vacuum gap.

51. The apparatus of claim 39 further comprising a conductive ring underlying said RF coupling ring, whereby said RF coupling has an axial thickness less than that of said conductive base.

52. The apparatus of claim 39 wherein said conductive base comprises:
an upper coolant manifold having a generally planar extent and located at a first axial location;
a lower coolant manifold having a generally planar extent corresponding to the planar extent of said upper coolant manifold and located a a second axial location below the axial location of said upper coolant manifold;
an intermediate wall separating said upper and lower coolant manifolds and defining a ceiling of said lower coolant manifold and a floor of said upper coolant manifold;
a top wall overlying said intermediate wall and defining a ceiling of said upper coolant manifold;
a bottom wall underlying said intermediate wall and defining a floor of said lower coolant manifold;
a first external conduit connected through said bottom wall to said lower coolant manifold;
a second external conduit passing through said bottom wall and connected through said intermediate wall to said upper coolant manifold;
plural parallel passages in said intermediate wall for coolant flow between said upper and lower coolant manifolds; and
a coolant pump output port connected to an output end of one of said first and second external conduits and a coolant pump return port connected to another one of said first and second external conduits.

53. The apparatus of claim 52 further comprising plural holes in the bottom surface of said top wall whereby to increase surface area contacting coolant in said upper manifold.

54. The apparatus of claim 50 wherein said plural holes comprise a periodic array of square holes.

55. The apparatus of claim 54 wherein each of said square holes has a depth on the order of about 1 mm and a lateral extent on the order of about 1 mm.

56. The apparatus of claim 39 wherein said top layer is insulating, said apparatus further comprising:
a coaxial RF feed extending upwardly through said wafer support pedestal and having coaxial inner and outer conductors;
a thin planar conductive electrostatic chuck electrode inside said top layer;
a conductive chuck electrode connector connected to said chuck electrode and extending downwardly from said chuck electrode through said top layer and through said conductive base and having a connector end below said conductive base.

57. The apparatus of claim 56 further comprising:
an inner conductor terminator comprising a hollow cylindrical terminator conductor surrounding and spaced from said connector end of said chuck electrode connector, said hollow cylindrical terminator conductor having a lower end connected to a top end of said inner conductor and an upper end connected to said conductive base; and
an insulating support within and resting on said hollow cylindrical terminator conductor and holding said connector end of said conductive chuck electrode connector.

58. The apparatus of claim 56 further comprising:
a reactive element assembly connected between said elongate inner conductor and said conductive chuck electrode connector.

59. The apparatus of claim 58 wherein said reactive element assembly is supported on said insulating support.

60. The apparatus of claim 58 wherein said reactive element assembly provides a low impedance at the frequency of said RF power generator whereby to decrease a difference between RF potentials of said conductive base and electrostatic chuck electrode.

61. The apparatus of claim 58 wherein said reactive element assembly provides a high impedance at the frequency of said RF power generator whereby to increase a difference between RF potentials of said conductive base and electrostatic chuck electrode.

62. In a plasma reactor for processing a semiconductor wafer having a wafer diameter within a vacuum chamber of said reactor, a wafer support pedestal in said vacuum chamber extending upwardly from a floor of said vacuum chamber, said wafer support pedestal comprising:
an upper coolant manifold having a generally planar extent and located at a first axial location;
a lower coolant manifold having a generally planar extent corresponding to the planar extent of said upper coolant manifold and located a a second axial location below the axial location of said upper coolant manifold;
an intermediate wall separating said upper and lower coolant manifolds and defining a ceiling of said lower coolant manifold and a floor of said upper coolant manifold;
a top wall overlying said intermediate wall and defining a ceiling of said upper coolant manifold;
a bottom wall underlying said intermediate wall and defining a floor of said lower coolant manifold;
a first external conduit connected through said bottom wall to said lower coolant manifold;
a second external conduit passing through said bottom wall and connected through said intermediate wall to said upper coolant manifold;
plural parallel passages in said intermediate wall for coolant flow between said upper and lower coolant manifolds; and
a coolant pump output port connected to an output end of one of said first and second external conduits and a coolant pump return port connected to another one of said first and second external conduits.

63. The apparatus of claim 62 further comprising plural holes in the bottom surface of said top wall whereby to increase surface area contacting coolant in said upper manifold.

64. The apparatus of claim 62 wherein said plural holes comprise a periodic array of square holes.

65. The apparatus of claim 64 wherein each of said square holes has a depth on the order of about 1 mm and a lateral extent on the order of about 1 mm.
